(19) United States
(12) Patent Application Publication
(10) Pub. No.: US 2009/0153623 A1
(43) Pub. Date: Jun. 18, 2009

(54) INKJET PRINTHEAD AND METHOD OF MANUFACTURING THE SAME

(75) Inventors: Sung-joon PARK, Suwon-si (KR); Byung-ha Park, Suwon-si (KR); Dong-sik Shim, Suwon-si (KR); Hye-young Min, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/194,764

(22) Filed: Aug. 20, 2008

(30) Foreign Application Priority Data
Dec. 12, 2007 (KR) 2007-129082

(51) Int. Cl. B41J 2/05

(52) U.S. Cl. 347/63

(57) ABSTRACT

An inkjet printhead and a method of manufacturing the same. The inkjet printhead includes a substrate, a chamber layer to define an ink chamber on an upper portion of the substrate, and an adhesive portion to adhere to the substrate and the chamber, wherein the adhesive portion is formed of a phenolic sensitive resin.

### CROSS-REFERENCE TO RELATED APPLICATIONS

This application claims the benefit and priority under 35 U.S.C. §119(a) from Korean Patent Application No. 10-2007-0129082, filed on Dec. 12, 2007, in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to a bubble jet type inkjet printhead and a method of manufacturing the same. 2. Description of the Related Art

In general, ink ejection methods of an inkjet printer can be classified into an electro-thermal transducer type, which is also called a bubble jet type, and an electromechanical transducer type. In the electro-thermal transducer type, a heat source is used to generate bubbles in ink and the ink is ejected using the force of the generated bubbles. In the electro-mechanical transducer type, ink is ejected using a piezoelectric material, such that the ink is ejected according to the change in volume of the ink due to the deformation of the piezoelectric material.

In the electro-thermal transducer type, the heat is transferred to the ink that is in contact with a heater and thus the temperature of the water-soluble ink is increased above the boiling point of the ink. Thus, when the temperature of the ink is increased above the boiling point, bubbles are formed, and these bubbles pressurize the ink around the bubbles. The pressurized ink is ejected through nozzles due to the difference between the atmospheric pressure and the pressure of the ink. While being ejected onto the paper, the ink forms ink droplets in order to minimize its surface energy. A drop-on-demand type is a type in which the above process is performed using a computer whenever necessary.

The electro-thermal transducer type has a problem in terms of durability due to serial shocks generated by pressure of ink droplets generated by thermal energy. Also, it is difficult to control the size of the ink droplets and to increase the speed of ejecting the ink droplets.

Recently, an array head type or a line head type including an inkjet printhead corresponding to the width of a sheet of paper is under development as the needs for higher operation speed and high integration increase.

In the electro-mechanical transducer type, a piezoelectric material is attached to a diaphragm to pressurize a chamber of a printhead. Then, pressure is applied to the chamber to eject ink using the piezoelectric characteristic of generating a force when a voltage is applied. Thus, force is generated according to the applied voltage so as to apply pressure to the chamber, and thereby having an excellent characteristic in terms of speed.

The electro-thermal transducer type inkjet printhead includes a substrate, a chamber, and a nozzle plate. The substrate includes a heater generating heat and a manifold supplying ink. The chamber surrounds the heater and forms an ink chamber for temporarily storing ink that is to be ejected. The nozzle plate is disposed over the chamber and includes a nozzle from which the ink is ejected, and the chamber is attached to the substrate using an adhesive layer that is formed of a resin-based material. When the adhesive layer is formed of an insensitive material, the adhesive layer is formed by patterning using a dry etching method or a wet etching method. When the adhesive layer partially contacts with ink stored in the ink chamber, the adhesive layer should not react with the ink even when the adhesive layer contacts with the ink for long hours. Accordingly, the adhesive layer must have a high chemical resistance.

The insensitive adhesive layer is ideally patterned using photoresist via a photolithography process. Accordingly, the adhesive layer is formed on the substrate, and photoresist is applied on the adhesive layer. Then, a photo mask having a desired pattern is formed on the photoresist and ultraviolet rays are irradiated thereon to pattern the photoresist in a desired form. Then, the photoresist is developed with an etching solution, and the adhesive layer is patterned in a desired pattern by using an etching method. Accordingly, when the insensitive adhesive layer is used, a process using photoresist is further necessary.

Also, when a part of the adhesive layer contacts with ink stored in the ink chamber, an adhesive layer having chemical characteristics, in that the adhesive layer does not react with the ink, should be used. Accordingly, the material for forming the adhesive layer is limited.

### SUMMARY OF THE INVENTION

The present general inventive concept provides an inkjet printhead and a method of manufacturing the same to reduce the number of manufacturing processes by using a sensitive material and include an adhesive layer formed so as not to contact with ink.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet printhead, including a substrate, a chamber to define an ink chamber in an upper portion of the substrate, and an adhesive portion to attach the substrate and the chamber, wherein the adhesive portion is formed of a phenolic sensitive resin.

The foregoing and/or other aspects and utilities of the present general inventive concept may also be achieved by providing a method of manufacturing an inkjet printhead, the method including forming at least one heat source and an electrode on a substrate, forming an adhesive portion formed of a phenolic sensitive resin on the substrate, forming a chamber on the adhesive portion to define an ink chamber that temporarily stores ink to be ejected so that the adhesive portion does not contact with the ink; and forming a nozzle plate on the chamber such that at least one nozzle is formed in the nozzle plate.

The foregoing and/or other aspects and utilities of the present general inventive concept may be achieved by providing an inkjet printhead, including a substrate, a chamber layer to define an ink chamber on an upper portion of the substrate, and an adhesive portion to attach the substrate and the chamber layer, wherein at least a portion of the chamber layer is disposed between the ink chamber and the adhesive portion.

The chamber layer may include the at least a portion and a middle portion receded from the at least a portion, and the adhesive portion may be disposed between the middle portion and the substrate.

The adhesive portion may be spaced apart from the ink chamber by a distance to correspond to a thickness of the at least a portion of the chamber layer.

The chamber layer may include a surface to define the ink chamber, and the surface is formed on the at least a portion of the chamber layer.

The substrate may include one or more layers as a heat source and an electrode formed thereon to heat ink stored in the ink chamber, and the adhesive portion may be spaced-apart from the ink by a thickness of the at least a portion of the chamber layer.

The adhesive portion may have a width narrower than a thickness of the chamber layer.

The adhesive portion nay have a height higher than a thickness of a layer disposed between the substrate and the chamber layer.

The adhesive portion may not be exposed to the ink chamber.

The inkjet printhead may further include a heat source and an electrode formed on the substrate, and a passivation layer formed on the heat source and the electrode, and the adhesive portion may be disposed between the passivation layer and the chamber layer.

The inkjet printhead may further include an anti-cavitation layer formed on the passivation layer in the ink chamber, and the anti-cavitation layer may be disposed not to contact the adhesive portion.

The passivation layer and the adhesive portion may be spaced-apart substantially by a distance to correspond to a thickness of the at least a portion of the chamber layer.

The adhesive portion and the at least a portion of the chamber layer may be formed on the passivation layer in a direction of a plane between the chamber layer and the passivation layer.

### BRIEF DESCRIPTION OF THE DRAWINGS

The above and other features and advantages of the present general inventive concept will become more apparent by describing in detail exemplary embodiments thereof with reference to the attached drawings in which:

FIGS. 1 through 9 are cross-sectional views illustrating a method of manufacturing an inkjet printhead, according to an embodiment of the present general inventive concept; and

FIG. 10 is a perspective view illustrating a method of examining adhesion of an adhesive portion of an inkjet printhead, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

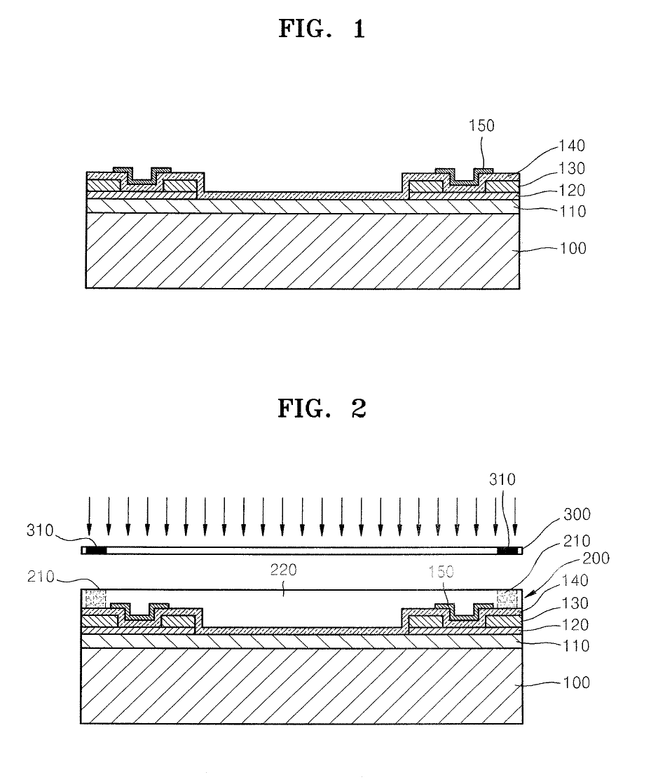

FIGS. 1 through 9 are cross-sectional views of a method of manufacturing an inkjet printhead, according to an embodiment of the present general inventive concept.

A structure of the inkjet printhead formed according to the present embodiment of the present general inventive concept will now be described with reference to the accompanying drawings.

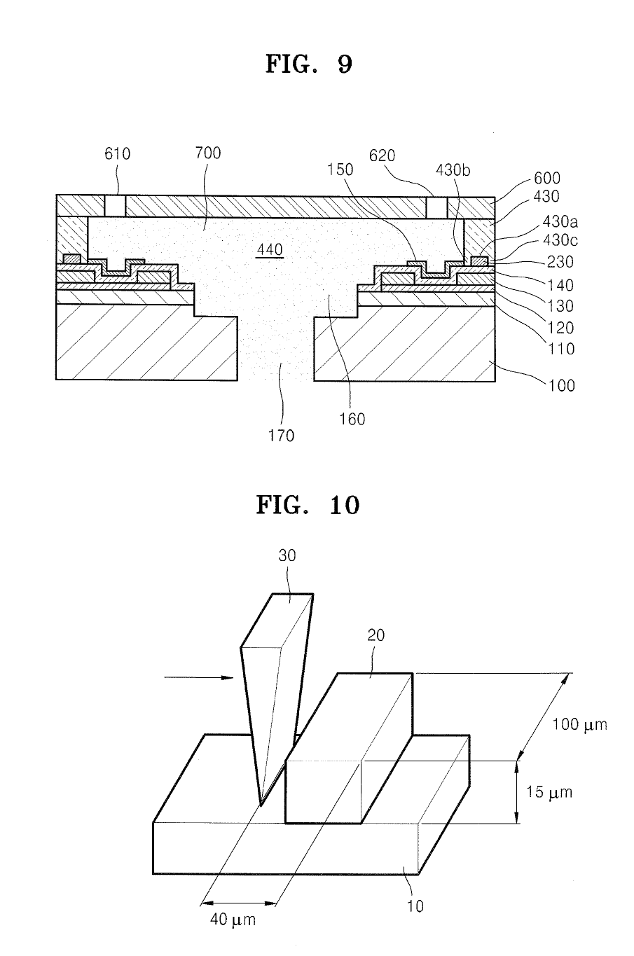

Referring to FIG. 9, a manifold 170 and a trench 160 are formed in a substrate 100 so as to supply ink 700 to an ink chamber 440. An oxide film 110 is formed on the substrate 100. A heat source 120 is formed on the oxide film 110 to form bubbles by applying heat to the ink 700. An electrode 130 is formed on the heat source 120 to supply current to the heat source 120. The electrode 130 is isolated from the ink 700 by a protective layer in order to prevent the ink 700 stored in the ink chamber 440 from contacting with the electrode 130 and thus corroding the electrode 130. The inkjet printhead further includes a passivation layer 140 and an anti-cavitation layer 150.

A chamber layer 430 is formed in an upper portion of the substrate 100 to define the ink chamber 440, and is attached to an upper side of the substrate 100, more particularly, to the passivation layer 140 by an adhesive portion 230. The adhesive portion 230 is completely covered by the chamber 430, and thus not externally exposed. Accordingly, the adhesive portion 230 does not contact the ink 700 stored in the ink chamber 440. Thus, occurrences of a chemical reaction between the adhesive portion 230 and the ink 700 stored in the ink chamber 440 can be prevented. Here, the above-described layers, for example, the passivation layer 140, the electrode 130, the heat source 120, and/or oxide film 110, disposed between the chamber layer 430 and the substrate 100 may be referred to as the substrate 100.

The chamber layer 430 may include a middle portion 430a and exterior portions 430b and 430c disposed opposite sides of the middle portion 430a. The adhesive portion 230 is formed between the middle portion 430a and the passivation layer 140. When the middle portion 430a has a groove shape, the adhesive portion 230 may be disposed in the middle portion 430a. Since the exterior portions 430b and 430c directly contact the passivation layer 140, the adhesive portion 230 is spaced-apart from a surface of the chamber layer 430 defining the ink chamber by a distance such that the exterior potions 430b and/or 430c keep the ink stored in the ink chamber 430 from contacting the adhesive portion 230.

It is possible that the chamber layer 430 may have the middle portion 430a and the exterior portion 430b.

It is also possible that the exterior portion 430 of the chamber layer 430 may be disposed between the adhesive portion 230 and a portion of the anti-cavitation layer 150.

A height of the adhesive portion 230 in a direction parallel to the chamber layer 430 may be same as or higher that a thickness of the anti-cavitation layer 150 in a direction, and a width of the adhesive portion 230 is narrower than a width of the chamber layer in a second direction perpendicular to the direction and parallel to a plane when the chamber layer 430 and the passivation layer 140 contact. It is possible that the height of the adhesive portion 230 may be higher than a thickness of the passivation layer 140 and lower than a thickness of the electrode 130.

A nozzle plate 600 that includes a plurality of nozzles 610 and 620 that eject ink to an outside thereof is formed to cover the upper portion of the ink chamber 440. The nozzles 610 and 620 may be respectively formed in the nozzle plate 600 to respectively correspond to the anti-cavitation layer 150 or the heat source 120.

The method of manufacturing the inkjet printhead according to the present embodiment of the present general inventive concept will now be sequentially described with reference to the accompanying drawings.

Referring to FIG. 1, the oxide film 110, formed of SiO2 with a predetermined thickness, is formed on the substrate 100 formed of Si. One or more heat sources 120, formed of TaN, are disposed on the oxide film 110 at a predetermined interval so as to apply heat to ink. At least one electrode 130, formed of Al, is disposed on the heat source 120 so as to supply power from a power source to the corresponding heat source 120. A passivation layer 140, formed of SiN with a predetermined thickness, is formed on the oxide film 110, the heat source 120, and the electrode 130. An anti-cavitation layer 150, formed of Ta with a predetermined thickness, is formed on a part of the passivation layer 140 to directly contact the heat source 120 of the passivation layer 140.

The heat source 120, the electrode 130, the passivation layer 140, and the anti-cavitation layer 150 are formed using a photolithography process that is a widely known method to one of ordinary skill in the art, and thus the description thereof will be omitted.

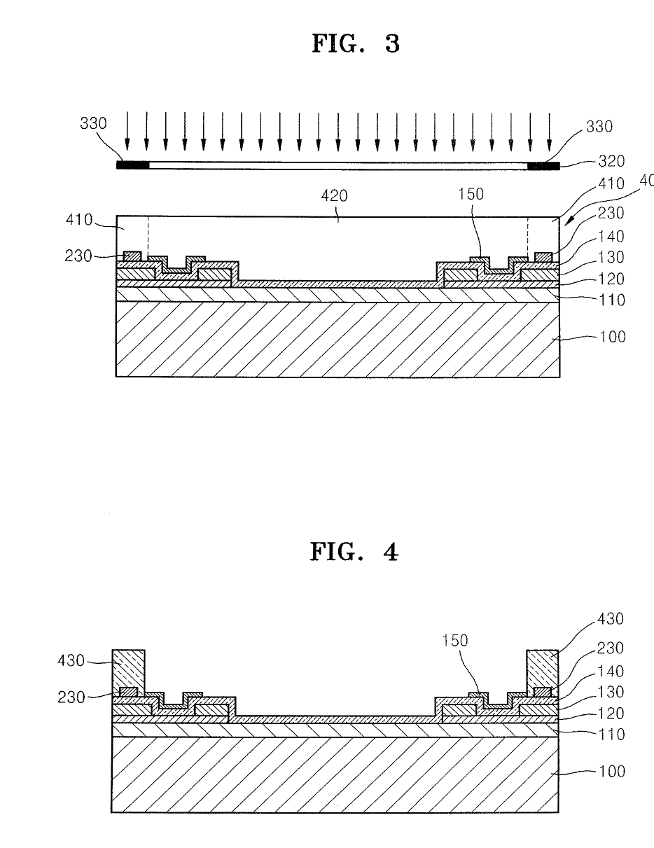

Referring to FIG. 2, an adhesive layer 200 is formed with a thickness in the range of 2 to 3 μm so as to cover the passivation layer 140 and the anti-cavitation layer 150. Then, a photo mask 300, in which a blocking portion 310 is patterned to form the adhesive portion 230 (see FIG. 3), is used to cover the adhesive layer 200, and then ultraviolet rays are irradiated thereon.

The ultraviolet rays pass through the photo mask 300, except the blocking portion 310. At this point, the adhesive layer 200 is divided into portions 210, on which the ultraviolet rays did not pass through the photo mask 300 due to the blocking portion 310, and a portion 220, on which ultraviolet rays passed through the photo mask 300.

When the substrate 100 is disposed in a predetermined solution, the portion 220 is etched because the portion 220 is formed of a negative sensitive material, however, the portions 210 are not etched and each become the adhesive portion 230 (see FIG. 3).

The adhesive layer 200 may be formed of a phenolic material, and may use WPR-1201 made by JSR Co., Ltd. The WPR-1201 is a phenolic sensitive resin and can be used in a photolithography process. Accordingly, since the WPR-1201 does not need to use a process using photoresist, unlike other materials, the manufacturing process can be simple.

Referring to FIGS. 3 and 4, a chamber layer 400 is formed with a thickness in the range of 10 to 15 μm on the substrate 100 on which at least one adhesive portion 230 is formed. Then, a photo mask 320, in which a blocking portion 330 to form the chamber 430 is patterned, is used to cover the chamber layer 400, and ultraviolet rays are irradiated thereon.

The ultraviolet rays pass through the photo mask 300, except the blocking portion 330. At this point, the chamber layer 400 is divided into portions 410 on which the ultraviolet rays did not pass through the blocking portion 330 and a portion 420 on which ultraviolet rays passed through the photo mask 300.

When the substrate 100 is disposed in a predetermined solution, the portion 420 is etched because the chamber layer 400 is formed of a negative sensitive material, however, the portion 410 are not etched and become the chamber layer 430.

At this point, the adhesive portion 230 is completely covered by the chamber layer 430, and thus not externally exposed from the chamber layer 430. Accordingly, since the adhesive portion 230 does not contact with ink, the adhesive portion 230 cannot be corroded.

An experiment for examining adhesion of the adhesive portion 230 was performed using an adhesive test piece 20 as the adhesive portion 230.

FIG. 10 is a view illustrating a method of examining adhesion of the adhesive portion 230, according to an embodiment of the present general inventive concept.

Referring to FIG. 10, an adhesive test piece 20 having a width, a height, and a thickness of 100 μm, 40 μm, and 15 μm, respectively, is attached to a substrate 10. A pressing tool 30, for applying force to the adhesive test piece 20, is disposed beside the adhesive test piece 20 to apply force to the adhesive testy piece 20. The substrate 10 may be the same as the substrate 100. The pressing tool 30 is pushed in an arrow direction. When the adhesive test piece 20 is separated from the substrate 10 by applying force to the adhesive test piece 20, the force applied to the pressing tool 30 is measured.

Table 1 shows the result.

TABLE 1

| frequency | adhesion(Kgf) |
|---|---|
| 1 | 41.2 |
| 2 | 40.3 |
| 3 | 40.1 |
| 4 | 40.3 |
| 5 | 40.6 |
| 6 | 40.1 |
| 7 | 41.3 |
| 8 | 40.1 |
| 9 | 38.5 |
| 10 | 40.4 |
| average | 40.29 |

According to the above Table 1, the adhesion of the adhesive test piece 20 is over 40 Kgf.

The adhesive test piece 20 of FIG. 10 may correspond to the adhesive portion 230 of FIG. 3 and/or the chamber layer 430 with the adhesive portion 230 of FIG. 4.

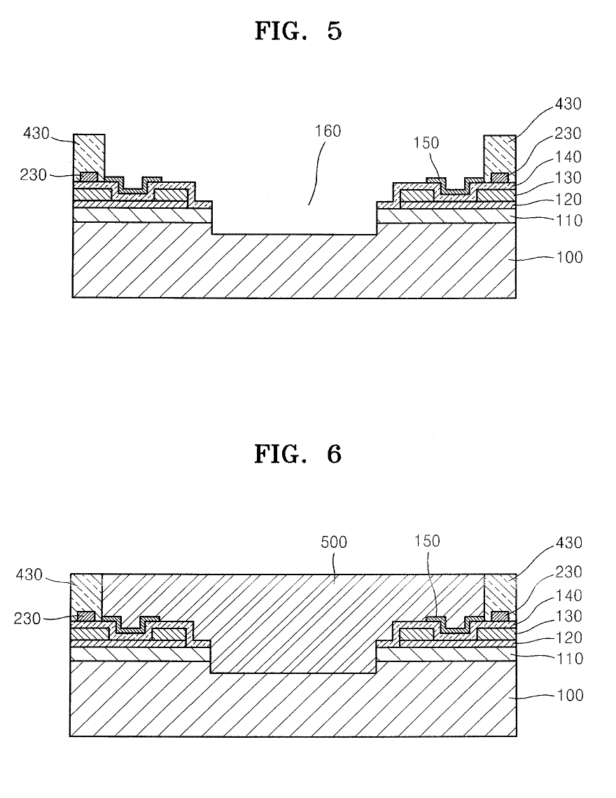

Referring to FIG. 5, the trench 160 is formed by removing a portion of the passivation layer 140, the oxide film 110, and the substrate 100. The trench 160 is used as a portion of an ink path to supply ink into the chamber 430.

Referring to FIG. 6, a sacrificial layer 500 formed of, for example, Odur, is formed on the substrate 100 so that the sacrificial layer 500 is flush with the surface of the chamber 430.

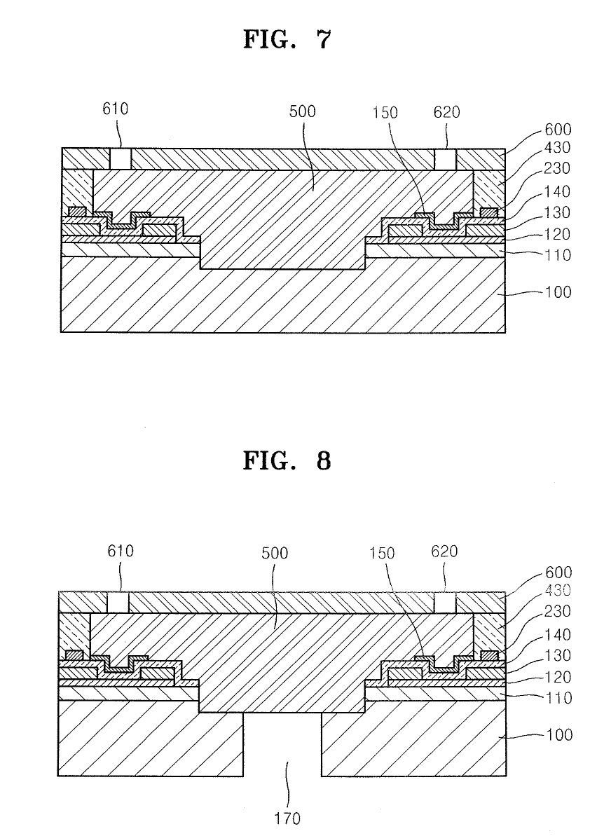

Referring to FIG. 7, the nozzle plate 600 including at least one nozzle 610 as a path for ejecting ink is formed on the sacrificial layer 500.

Referring to FIG. 8, the sacrificial layer 500 is formed on the substrate 100 so that a top and bottom of the substrate 100 and the sacrificial layer 500, respectively, contact each other. The manifold 170 is formed in the substrate 100 so that the manifold 170 contacts the bottom of the sacrificial layer 500.

Referring to FIG. 9, the sacrificial layer 500 is removed, and the removed part becomes the ink chamber 440 for temporarily storing ink that is to be ejected. Accordingly, the ink is introduced into the ink chamber 440 through the manifold 170 that is formed in the substrate 100 and the trench 160.

While the present general inventive concept has been particularly shown and described with reference to exemplary embodiments thereof, it will be understood by one of ordinary skill in the art that various changes in form and details may be made therein without departing from the spirit and scope of the present general inventive concept as defined by the following claims.

What is claimed is:

1. An inkjet printhead, comprising:
a substrate;
a chamber layer to define an ink chamber in an upper portion of the substrate; and
an adhesive portion to attach the substrate and the chamber,
wherein the adhesive portion is formed of a phenolic sensitive resin.

2. The inkjet printhead of claim 1, wherein the phenolic sensitive resin is negative sensitive resin.

3. The inkjet printhead of claim 1, wherein the adhesion of the adhesive portion is over 40 Kgf.

4. The inkjet printhead of claim 1, wherein the adhesive portion does not contact with ink stored in the ink chamber.

5. A method of manufacturing an inkjet printhead, the method comprising:
forming at least one heat source and an electrode on a substrate;
forming an adhesive portion, formed of a phenolic sensitive resin, on the substrate;
forming a chamber layer on the adhesive portion to define an ink chamber to temporarily store ink to be ejected so that the adhesive portion does not contact with the ink; and
forming a nozzle plate on the chamber such that at least one nozzle is formed in the nozzle plate.

6. The method of claim 5, wherein the adhesive portion is formed using a photoresist process.

7. The method of claim 6, wherein the adhesion of the adhesive portion is over 40 Kgf.

8. The method of claim 5, wherein the forming of the chamber comprises forming the chamber layer so that the adhesive portion does not contact with ink stored in the ink chamber.

9. An inkjet printhead, comprising:
a substrate;
a chamber layer to define an ink chamber on an upper portion of the substrate; and
an adhesive portion to attach the substrate and the chamber layer,
wherein at least a portion of the chamber layer is disposed between the ink chamber and the adhesive portion.

10. The inkjet printhead of claim 9, wherein the chamber layer comprises the at least a portion and a middle portion receded from the at least a portion, and the adhesive portion is disposed between the middle portion and the substrate.

11. The inkjet printhead of claim 10, wherein the adhesive portion is spaced apart from the ink chamber by a distance to correspond to a thickness of the at least a portion of the chamber layer.

12. The inkjet printhead of claim 9, wherein the chamber layer comprises a surface to define the ink chamber, and the surface is formed on the at least a portion of the chamber layer.

13. The inkjet printhead of claim 9, wherein the substrate comprises one or more layers as a heat source and an electrode formed thereon to heat ink stored in the ink chamber, and the adhesive portion is spaced-apart from the ink by a thickness of the at least a portion of the chamber layer.

14. The inkjet printhead of claim 9, wherein the adhesive portion has a width narrower than a thickness of the chamber layer.

15. The inkjet printhead of claim 9, wherein the adhesive portion is not exposed to the ink chamber.
